(19) United States
(12) Patent Application Publication
(10) Pub. No.: US 2004/0222578 A1
(43) Pub. Date: Nov. 11, 2004

(54) Prestressed elastic device with cage and use thereof

(76) Inventors: Lionel Bourgois, Drancy (FR); Philippe Bourlon, Dammartin En Goele (FR); Martin Thurner, Rettenberg (DE); Francois Gaffe, Drancy (FR)

Correspondence Address: Leo H McCormick Jr, Bosch Braking Systems, 2112 Mishawaka Avenue, P O Box 4721, South Bend, IN, 46634-4721, US

(21) Appl. No.: 10/475,904

(22) PCT Filed: Apr. 23, 2002
(86) PCT No.: PCT/FR02/01394

(30) Foreign Application Priority Data
Apr. 26, 2001 (FR) 01/05666

(51) Int. Cl. F16F 1/06

(52) U.S. Cl. 267/169

(57) ABSTRACT

A prestressed resilient device including a spring (1) and a prestressing cage (2) having a variable axial length up to a maximum length (LO) and being inserted inside the spring (1). The cage (2) includes two U-shaped distance pieces (3, 4) that are coupled through their bases that keep the ends (11, 12) of the spring at a maximum distance apart while enabling them to draw nearer to each other.

This invention relates generally to a mechanical device, capable of exerting a controlled resilient force.

More particularly, according to a first aspect, the present invention deals with a prestressed resilient device, which comprises a prestressed resilient member exhibiting an elongate shape along an axis and forming an axial passage extending between the first and second ends of said resilient member, and a prestressing cage with a variable axial length up to a maximum length, such cage being inserted in the axial passage and resting on the first and second ends of the resilient member so as to keep them at a maximum distance apart, though enabling them to draw nearer to each other.

Such devices have been known for decades and used in numerous sectors of mechanical engineering.

In spite of the relatively simple structures of such devices, there are still some difficulties about their manufacturing, more especially in the case of a mass production.

Therefore, it is an object of this invention to provide a prestressed resilient device, the manufacturing or the assembling of which may be optimized thanks to at least a reduction of the cost of the tooling and/or a reduction of the assembly cycle time.

To this end, the device according to the invention, which is consistent with the generic definition as per the introductory part hereinabove, is mainly characterised in that the cage comprises a first and a second distance piece, each of them having two arms with respective free ends and respective coupled ends through which they are joined up together into a common base, the free ends of the arms of the first and second distance pieces being bent outwards away from the axis so as to constitute first and second respective flanges which retain the first and second ends of the prestressed resilient member, respectively, and wherein the distance pieces are coupled through their bases.

In a preferred manner, the free ends of the arms of each distance piece are resiliently biased so as to move away from each other, and away from the axis, and they are applied onto the prestressed resilient member.

Thus, the distance pieces may be fitted the one inside the other and rest the one on the other by their bases.

Each distance piece is made, for instance, of a spring steel, and the prestressed resilient member may be a metal spring and/or a helical spring.

Besides, such device may comprise means for the adjustment of the maximum length of the cage.

Said adjusting means may comprise, e.g., a median fold made in the base of each distance piece between the arms of said distance piece, and protruding in the direction of the free ends of the arms of this distance piece.

According to a variant, such adjusting means may comprise a boss, made in the base of one of the distance pieces, or a shim placed between the bases of the distance pieces.

In the latter case, the base of each distance piece may advantageously be substantially circular so as to keep the shim in position.

The device according to this invention is outstandingly suitable for the return of a piston of a braking master cylinder.

Other features and advantages of the present invention will be apparent from the following detailed description, by way of example and by no means as a limitation, when taken in conjunction with the accompanying drawings, in which:

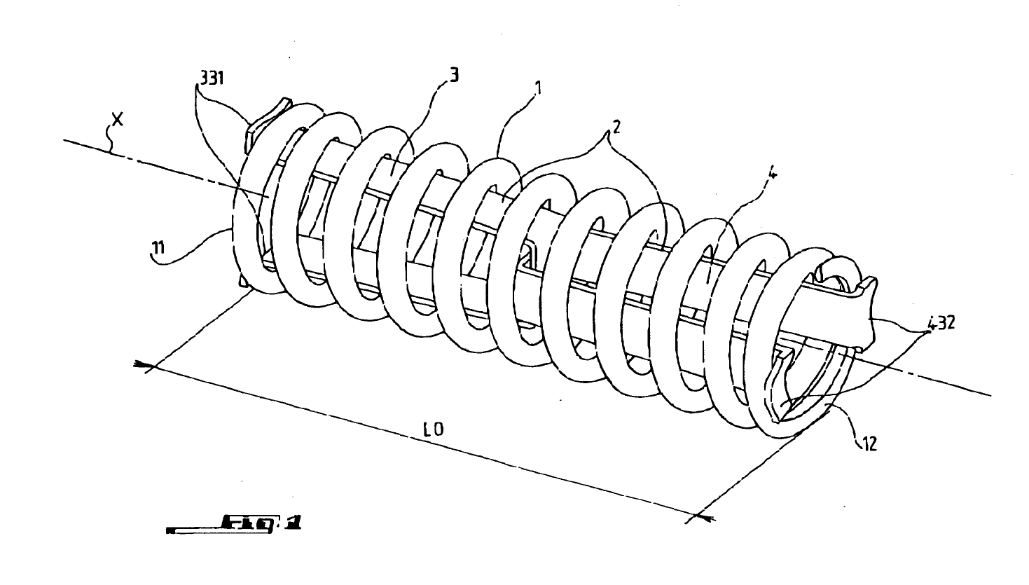

FIG. 1 is a perspective view of a device according to the invention;

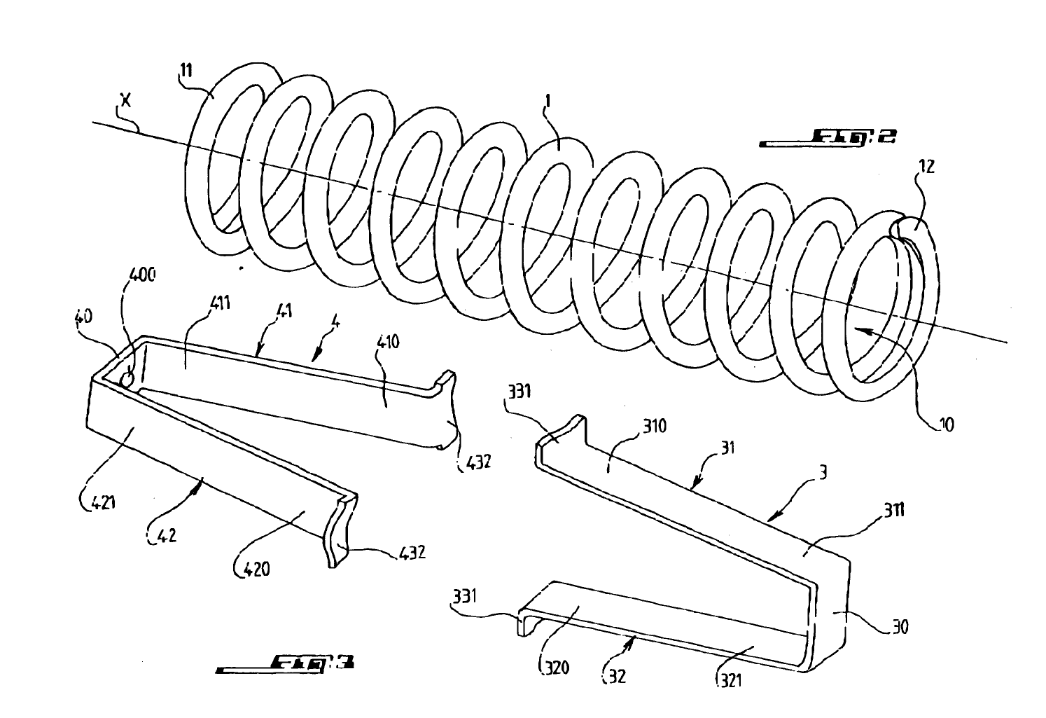

FIG. 2 is a perspective view of a resilient member before it is integrated into the device according to the invention;

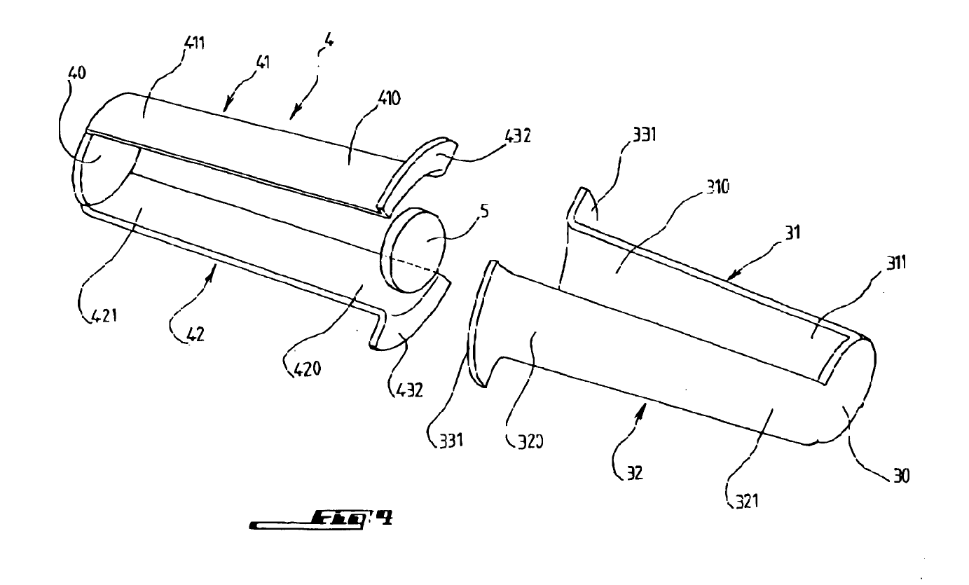

FIG. 3 is a perspective view of two distance pieces, constituting the elements of a cage according to a first variant, prior to the integration of such cage into the device according to the invention;

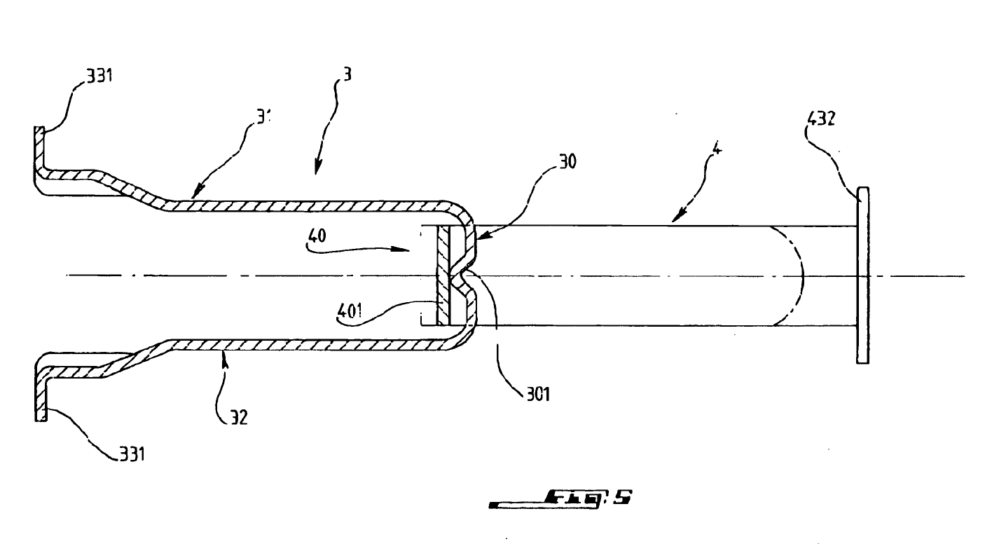

FIG. 4 is a perspective view of two distance pieces, constituting the elements of a cage according to a second variant, prior to the integration of such cage into the device according to the invention; and

FIG. 5 is a longitudinal sectional view, showing a cage according to the invention, comprising length-adjusting means according to a preferred embodiment of the invention.

As set out hereinbefore, the invention relates to a prestressed resilient device of the type comprising primarily a prestressed resilient member 1, e.g. a helical spring made up of steel, and a prestressing cage 2.

Whatever the particular shape selected for the prestressed resilient member 1 may be, such member exhibits an elongate shape along a longitudinal axis X, and it forms an axial passage 10 extending between the ends 11 and 12 of said resilient member 1.

The prestressing cage 2, having a variable axial length up to a maximum length LO, is fitted inside the axial passage 10 and rests on the ends 11 and 12 of the spring 1 so as to keep them at a maximum distance from each other, as set by the maximum length LO of the cage, though enabling these ends 11 and 12 to draw nearer to each other.

In accordance with the invention, the cage 2 comprises two distance pieces 3 and 4.

Each distance piece has two arms, such as 31 and 32 for the distance piece 3, and 41, 42 for the distance piece 4.

The two arms of each distance piece comprise respective free ends, such as 310, 320 and 410, 420, and respective coupled ends, such as 311, 321 and 411, 421.

Each one of the distance pieces 3 and 4 has a base, such as 30 and 40, through which the coupled ends, such as 311, 321 and 411, 421, are joined up together.

On the opposite side, the free ends 310, 320 and 410, 420 of the arms of the distance pieces 3 and 4 are bent outwards away from the axis X so as to constitute respective flanges, namely 331 for the distance piece 3 and 432 for the distance piece 4.

FIG. 1 shows that the function of the flanges 331 and 432, defined by the distance pieces 3 and 4, consists in retaining the corresponding ends 11 and 12 of the spring 1, the distance pieces 3 and 4 being otherwise coupled through their respective bases 30 and 40.

Each distance piece 3, 4 is, e.g., made up of a spring steel and exhibits resilient properties transversely to the axis X, that is in the direction corresponding to the mutual closing and opening motions of the arms 31, 32 and 41, 42.

Therefore, the free ends 310, 320 and 410, 420 of the arms of each one of the distance pieces 3 and 4 may be resiliently biased so as to move away from each other and from the axis X, and so as to be applied onto the inner periphery of each one of the corresponding ends 11 and 12 of the spring 1.

As shown in FIG. 1 too, in a preferred manner, the distance pieces 3 and 4 are merely fitted the one inside the other, with the result that they rest the one on the other by their respective bases 30 and 40.

Should it be necessary to adjust the maximum length LO of the cage 2, a boss, such as 400 (FIG. 3) may be provided in the base 40 of one of the distance pieces 3 and 4, so as to bring the flanges 331 and 432 closer to each other by a distance corresponding to the height of such boss.

An alternative (FIG. 4), a shim 5 may be put in between the bases 30 and 40 of the distance pieces 3 and 4.

In the latter case, it may prove convenient that the bases 30 and 40 of the distance pieces 3 and 4 exhibit a substantially circular shape, in order to provide a large and stable support for the shim 5.

Nevertheless, the preferred embodiment of an adjustable maximum-length cage 20 is represented in FIG. 5.

In such a cage, the base 30, 40 of each distance piece 3, 4 comprises a median fold, such as 301, 401, disposed between the arms 31 and 32 or 41 and 42 of the distance piece in question, and protruding in the direction of the free ends of the arms of these arms.

Thanks to this arrangement, the mutual bearing of the folds 301 and 401 the one on the other provides a knuckle-like contact for the distance pieces 3 and 4, and the maximum length LO of the cage may be increased owing to a plastic squeezing of the folds 301 and 401.

Although the device according to the invention may serve quite a number of purposes, the most preferred implementation concerns the field of hydraulic braking master cylinders, in which the device may carry out the return of a primary piston and/or of the secondary piston, such application corresponding to a mass production requiring a very high reproducibility of the performance.

1. (Cancelled)

2. (Cancelled)

3. (Cancelled)

4. The resilient device according to claim 3, characterised in that each distance piece (3, 4) is made up of a spring steel.

5. The resilient device according to claim 4, characterised in that the prestressed resilient member (1) is a metal spring.

6. The resilient device according to claim 5, characterised in that the prestressed resilient member (1) is a helical spring.

7. The resilient device according to claim 6, characterised in that it comprises means for the adjustment of the maximum length of the cage.

8. The resilient device according to claim 7, characterised in that said means for the adjustment of the maximum length comprise a median fold (301, 401) made in the base (30, 40) of each distance piece (3, 4) between the arms (31, 32; 41, 42) of said distance piece (3, 4), and protruding in the direction of the free ends (310, 320; 410, 420) of the arms (31, 32; 41, 42) of this distance piece.

9. The resilient device according to claim 7, characterised in that said means for the adjustment of the maximum length comprise a boss (400), made in the base (40) of one of the distance pieces (3, 4).

10. The resilient device according to claim 7, characterised in that said means for the adjustment of the maximum length comprise a shim (5), placed between the bases (30, 40) of the distance pieces (3, 4).

11. The resilient device according to claim 10, characterised in that the base (30, 40) of each distance piece (3, 4) is substantially circular.

12. The resilient device according to claim 13 for returning a piston of a braking master cylinder.

13. A prestressed resilient device, comprising a prestressed resilient member (1) exhibiting an elongate shape along an axis (X) and forming an axial passage (10) extending between first and second ends (11, 12) of said resilient member (1), and a prestressing cage (2) with a variable axial length up to a maximum length (LO), said cage being inserted in said axial passage (10) and resting on the first and second ends (11, 12) of said resilient member (1) so as to keep said ends at a maximum distance apart, though enabling said ends to draw nearer to each other, characterised in that said cage (2) comprises a first and a second distance piece (3, 4), each distance piece having two arms (31, 32; 41, 42) with respective free ends (310, 320; 410, 420) and respective coupled ends (311, 321; 411, 421) that are joined up together into a common base (30, 40), the free ends (310, 320; 410, 420) of the arms (31, 32; 41, 42) of the first and second distance pieces (3, 4) being bent outwards away from the axis (X) to constitute first and second respective flanges (331; 432) that retain said first and second ends (11, 12) of said prestressed resilient member (1) respectively, and wherein said distance pieces (3, 4) are coupled through their bases (30, 40) and said free ends (310, 320; 410, 420) of the arms (31, 32; 41, 42) of each distance piece (3, 4) are resiliently biased so as to move away from each other and away from the axis (X), said distance pieces (3, 4) being fitted the one inside the other and rest on each other at the bases (30, 40) when applied onto said prestressed resilient member (1).
